(19) United States
(12) Patent Application Publication
(10) Pub. No.: US 2011/0191352 A1
(43) Pub. Date: Aug. 4, 2011

(54) Socially- And Context-Aware People-Matching Systems and Methods Relating Thereto

(75) Inventors: Quentin Jones, New Brunswick, NJ (US); Julia Mayer, Brooklyn, NY (US); Sara Gatmir Motahari, Berkely, CA (US)

(73) Assignee: NEW JERSEY INSTITUTE OF TECHNOLOGY, Newark, NJ (US)

(21) Appl. No.: 12/959,919

(22) Filed: Dec. 3, 2010

Related U.S. Application Data
(60) Provisional application No. 61/266,465, filed on Dec. 3, 2009.

(51) Int. Cl. G06F 17/30

(52) U.S. Cl. 707/749; 707/E17.014

(57) ABSTRACT

Systems and methods for recommending matches of individuals is provided. A matching server is in communication with a plurality of computer systems operated by a plurality of users of the matching server, via a network (e.g., the Internet). Attribute information is received about a plurality of individuals, as well as a search query for an individual matching at least one desired characteristic specified by a user of the matching server. An affinity score is calculated based upon the attribute information and the search query, and local user context information and social relevance information corresponding to the plurality of individuals is received. An overall match score is calculated by adjusting the affinity score based upon the local user context information and the social relevance information. If the overall match score exceeds a pre-determined threshold, an alert is transmitted to the user of the matching server which identifies potential matches in the plurality of individuals.

### RELATED APPLICATIONS

This application claims the benefit of U.S. Provisional Patent Application Ser. No. 61/266,465 filed Dec. 3, 2009, the entire disclosure of which is expressly incorporated herein by reference.

### TECHNICAL FIELD

The present disclosure relates to social/people-matching systems, and more particularly, to methods and systems that enable socially-sensitive people-matching by considering the varying goals of users and system administrators as well as the user's context.

### BACKGROUND

Social matching (or people-matching) systems are computer-based systems that recommend individuals to each other. They can bring people together both online and in physical spaces, for a variety of reasons including shared interests, the wish for a good conversation, the need for professional knowledge or specific expertise to solve a problem, etc.

An important issue in social matching is determining what constitutes a good match. Many factors play into whether people are congenial to each other. For example, personal character, familiarity, and demographics can predict interpersonal attraction. When designing a social matching application, different user goals have to be considered, and user goals can differ depending on users' context.

Social matching systems typically provide individuals with access to an introduction mechanism which can be as simple as showing the profiles of matched individuals through listings or social network visualizations, or through context-aware match alerts and introduction management tools which aim to encourage interpersonal contact. Also, computer-mediated matchmaking is wide-spread on the Internet. Online dating web sites like eHarmony, OkCupid, and Match.com are popular. Examples of other social matching applications include SocialNet (which matches users based on location and also looks for mutual acquaintances for introduction) and Facebook's “People you may know” feature (which also uses social tie data to recommend people to each other). Additionally, social network and location data is leveraged by applications like Loopt Mix, Foursquare, and Brightkite to make match recommendations.

Previous research has identified four steps in the computer-assisted social matching process, namely: (1) modeling; (2) matching; (3) introducing; and (4) interacting. The first step of modeling requires the collection and analysis of user data which is then modeled to enable profiling of users. The second step involves the application of matching algorithms to the model. The third step involves the provision of visualizations, or alerts to users so they know who they should (or could) meet and provide some way for making contact. The fourth step gives users the ability to act on a match through collaboration tools or through ways of their own choosing.

Social matching systems have also been categorized into four types, namely: (1) explicit social matching systems (which compare public or user-constructed profiles and match people based on keywords where individuals are matched based on keywords); (2) social recommender systems for information needs (which match individuals based on users needs—there are two different roles, the information seeker and expert, who have to be matched); (3) information systems with implicit matching (which allow users to find potential matches by navigating information spaces. For example, data mining techniques are applied on public or user constructed profiles to create implicit user profiles for matching purposes; another approach of implicit matching is matching people based on what web sites they browse, what information they are interested in, or what music the user listens to); and (4) opportunistic social matching (which is independent of specific user requests but instead looks for opportunities to match people. The social matching system infers user interests from the current activity or record of past activity of the user and matches users based on shared interests. This technique is based on the assumption that some situations or activities are a good opportunity to match users and the system is designed to detect these opportunities).

Context-aware computing has been defined as the effort to taking advantages of contextual information to automatically adapt the operations of computing services for the user. Mobile computing is the approach of using a mobile device for computations. In a dynamic environment, an immense amount of context data can be collected, for example by mobile phones. This valuable context information can be leveraged and rich behavioral data can be derived because people carry their mobile phone with them almost all the time. Context of users in a certain situation can always change, and is defined by the physical, computing and social environment of a user as for example user location, user movement, environmental noise, temperature, or user activity.

Mobile devices can leverage context data to help people connect with familiar strangers. When the phone senses that two users are often co-present, this geotemporal pattern can be used for matching them. Additionally, absolute location or the place type like a coffee shop, the gym, and the theater can be used to derive users' interests as well as deciding on a suitable place for the match alert. Moreover, existing relationships together with their context (places like shared dorm, hobby or research lab) and social interactions can predict friendship.

### SUMMARY

The present disclosure relates to socially- and context-aware people-matching systems and methods therefor which are adaptable to varying user goals and provide high match quality. In one embodiment, the present disclosure relates to a method for matching individuals, comprising the steps of: receiving at a matching server attribute information about a plurality of individuals; receiving at the matching server a search query for an individual matching at least one desired characteristic specified by a user of the matching server; calculating using the matching server an affinity score based upon the attribute information and the search query; receiving at the matching server local user context information and social relevance information corresponding to the plurality of individuals; calculating an overall match score at the matching server by adjusting the affinity score based upon the local user context information and the social relevance information; determining whether the overall match score exceeds a pre-determined threshold; and if the overall match score exceeds the pre-determined threshold, electronically transmitting an alert to the user of the matching server identifying potential matches in the plurality of individuals.

In another embodiment, the present disclosure relates to a system for matching individuals, comprising: a matching server in communication with a plurality of computer systems operated by a plurality of users of the matching server, the matching server receiving attribute information about a plurality of individuals; means for receiving a search query for an individual matching at least one desired characteristic specified by a user of the matching server; means for calculating an affinity score based upon the attribute information and the search query; means for receiving local user context information and social relevance information corresponding to the plurality of individuals; means for calculating an overall match score by adjusting the affinity score based upon the local user context information and the social relevance information; means for determining whether the overall match score exceeds a pre-determined threshold; and means for transmitting an alert to the user of the matching server identifying potential matches in the plurality of individuals, if the overall match score exceeds the pre-determined threshold.

In another embodiment, the present disclosure relates to a computer-readable medium having computer-readable instructions stored thereon which, when executed by a computer system, causes the computer system to execute the steps of: receiving attribute information about a plurality of individuals; receiving a search query for an individual matching at least one desired characteristic specified by a user of the matching server; calculating an affinity score based upon the attribute information and the search query; receiving local user context information and social relevance information corresponding to the plurality of individuals; calculating an overall match score by adjusting the affinity score based upon the local user context information and the social relevance information; determining whether the overall match score exceeds a pre-determined threshold; and if the overall match score exceeds the pre-determined threshold, electronically transmitting an alert to the user of the matching server identifying potential matches in the plurality of individuals.

### BRIEF DESCRIPTION OF THE DRAWINGS

Features of the systems and methods of the present disclosure will be apparent from the following descriptions, taken in connection with the accompanying drawings, in which:

FIG. 1 is a diagram showing local context information, social relevance information, and user attribute information processed by the systems and methods of the present disclosure to provide recommendations for matching individuals;

FIG. 2 is a flowchart showing processing steps carried out by the systems and methods of the present disclosure for providing recommendations for matching individuals;

FIG. 3 is a diagram showing illustrative hardware and software components of the systems and methods of the present disclosure; and

FIG. 4 is a diagram showing, in greater detail, illustrative hardware and software components of the systems and methods of the present disclosure.

### DETAILED DESCRIPTION

The following is a detailed description provided to aid those skilled in the art in practicing the systems and methods of the present disclosure. Those of ordinary skill in the art may make modifications and variations in the embodiments described herein without departing from the spirit or scope of the systems and methods of the present disclosure. Unless otherwise defined, all technical and scientific terms used herein have the same meaning as commonly understood by one of ordinary skill in the art to which the systems and methods of the present disclosure belong. The terminology used in the disclosure herein is for describing particular embodiments only and is not intended to be limiting. All publications, patent applications, patents, figures and other references mentioned herein are expressly incorporated by reference in their entirety.

The present disclosure relates to socially-sensitive and context-aware people-matching systems and methods. Exemplary embodiments employ one or more of a variety of new and innovative approaches for generating suitable match alerts and the provision of privacy-sensitive introduction tools. In one embodiment, a socially-sensitive, context-aware people matching application is provided which provides users with valuable recommendations for matches with other users of the system. In this embodiment, the context of users is used to calculate interesting match recommendations and to send appropriate match alerts. Moreover, introduction mechanisms are provided which leverage social inference techniques and protect user privacy.

A key concern in social matching is computing matches, i.e. defining what makes a good match, and computing matches based on that. Currently, matches are calculated based on profile content, matching preferences, or social ties. However, these matching systems do not consider the broader social context. The systems and methods of the present disclosure calculate valuable people-matches and, when combined into one application, provide a new, innovative approach to social matchmaking.

Table 1, below, provides an overview of exemplary reasons implemented by the present invention for recommending matches. In the three columns, ‘user attributes’ are listed as fundamental affinity measures and ‘current local context’ and ‘social relevance’ are listed as match triggers/moderators:

TABLE 1
Reasons for Matching

Match Triggers/Moderators

| Affinity Measures | Current Local | |
|---|---|---|
| User Attributes | Context | Social Relevance |
| Interests | Proximity | Rarity/ |
| Demographics | Location | Prevalence |
| Geo-temporal Patterns | Time | |
| Personality | Temperature/ | |
| Needs | Weather | |
| Preferences | Mood | |
| Social Ties | Current Task/ | |
| | Activity | |

The systems and methods of the present disclosure utilize affinity measures as the basis of a matchmaking algorithm, and affinity measure are the primary reasons for recommending matches. User attributes such as interests, demographics, geo-temporal patterns, etc., are further measures which can be used by the present invention to identify possible affinities between users. Moreover, other user attributes which can be used to predict affinity between people are social ties or geotemporal patterns. Social ties can, for example, be obtained by analyzing social networking data and geotemporal patterns by data mining user's location logs collected by a mobile device. Matching can also be extended by using additional match moderators.

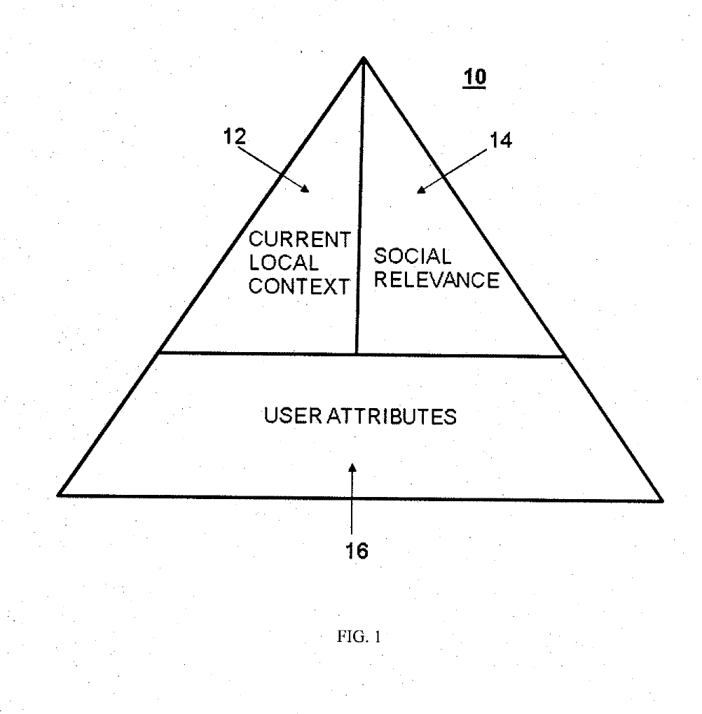

According to the systems and methods of the present disclosure, the match moderators are users' current local context and the social relevance of the match, and are considered as secondary reasons for recommending a match. FIG. 1 is a diagram (indicated generally at 10) which illustrates, in pyramid form, the relationship of user attributes along with contextual and social data on top to moderate matchmaking. As can be seen, user attributes 16 form the primary basis for recommending a match, and current local context 12 and social relevance 14 are secondary parameters for moderating match recommendation. Each of the parameters 12-16 are now discussed in detail.

User Attributes

User attributes 16 represent information such as interests, demographic information, hobbies, etc. This information forms the basis of the social matching functionality provided by the systems and methods of the present disclosure. People are matched based on the common assumption that people look for people who are similar to themselves. Similarities are found by electronically comparing user characteristics such as interests and demographics (e.g., by comparing information stored in a database relating to such user characteristics and applying the matching algorithm discussed herein to the stored information). Moreover, short-term and long-term trajectories (e.g., location logs, proximity patterns, etc.) can used to infer user's activities and interests from common places at which the user stays. Geotemporal data such as proximity patterns can be used to identify people who are around but who a user doesn't know yet (a so-called “familiar stranger”).

User needs or matching preferences are also user attributes which can be used by the systems and methods of the present disclosure to recommend matches. For example, if a student looks for someone to study for a chemistry exam on a university campus, then this information is used by the systems and methods of the present disclosure to find a match. In a professional context certain expertise can be localized and matched to information seekers. Moreover, when several people are working in a similar research area on similar research issues, they can find each other using the systems and methods of the present disclosure. People in need of help, information or skills are matched with people offering it or having the desirable user characteristics.

Other user attributes that can be utilized by the systems and methods of the present disclosure to recommend matches are existing social relationships and social closeness. Social ties are found by analyzing existing social network structures to find a not only physically but also socially close people, e.g., a friend of a friend. Based on social network relationships, the systems and methods of the present disclosure can match users with people having friends in common.

User's Local Context

Another type of match moderator capable of being utilized by the systems and methods of the present disclosure is the user's local context 12. Spatial proximity between users, user locations, the current time, temperature, or mood, as well as current task involvement or activity, is valuable contextual information which can influence the user's affinity to another user and his or her willingness to be introduced to another user at a given moment in time. By processing these types of information, the systems and methods of the present disclosure are context-aware and consider a broader range of user goals.

In one exemplary embodiment, the local user context is analyzed and used to moderate match-making. Local context information is modeled and stored in a database for future processing by the matching algorithm discussed herein. The model of users' local context includes real-time information such as the current location, proximity to other users, and current task involvement. This information can be acquired through electronic monitoring and modeling of the environment to understand various metrics such as shared places or common activities. Local context-awareness enables the matching algorithm/application to allocate matches in a relevant radius, at a certain location, or at a specific time. For example, a math tutor who is often at the same library is easier to meet than one who is not on the same campus very often.

Social Relevance

The second match moderator is the social relevance 14. This is a novel measure which is defined by rarity or prevalence of the match item. It is assumed that a comparatively rare match is more relevant to a user than a match on an attribute which is very common. Consider the following possible scenario. Daniel is a student at a university. He usually has many students around him while he is on campus. Therefore, the system does continually alert him to meet students from his university while he is on campus. However, when he leaves for a workshop in Italy, he is excited to find another student who attends his university at the same workshop, and a match alert can interest him in such a situation. Here, the similarity between Daniel and his match is not strong (the only shared attribute is attending the same university and maybe living in New Jersey); however it is the rareness and specialness of the match in the contextual condition that makes the match interesting. This example shows that the systems and methods of the present disclosure, which consider match rarity, can help to find a similar person who shares a very rare user attribute.

The systems and methods of the present disclosure, can, for example, consider the relative rarity of the interest or demographic information two users share. A shared, very rare interest is socially more relevant than a very common interest. The same is true for other user attributes. In this embodiment of the present invention, the affinity gains relevance when it is comparably rare. For example, the social relevance can be used to adjust the search radius for the match. When, for example, there are several people offering tutorials on a campus, the search can be constrained to the campus library, but if there only a few tutors around, the search radius can be increased to the entire campus. This shows that if the user need is very common, social relevance helps to find matches which are e.g. the closest or located at similar places.

As will be discussed in greater detail below, the systems and methods of the present disclosure also allow users to be introduced to each other when a potential match has been identified. Match alerts can be timed according to users' context in order to achieve minimum interruption or inappropriateness. The introduction mechanism can benefit from context-awareness by, for example, adjusting privacy restrictions and the information disclosure process appropriately for the user's context, particularly by taking social inference risk into account.

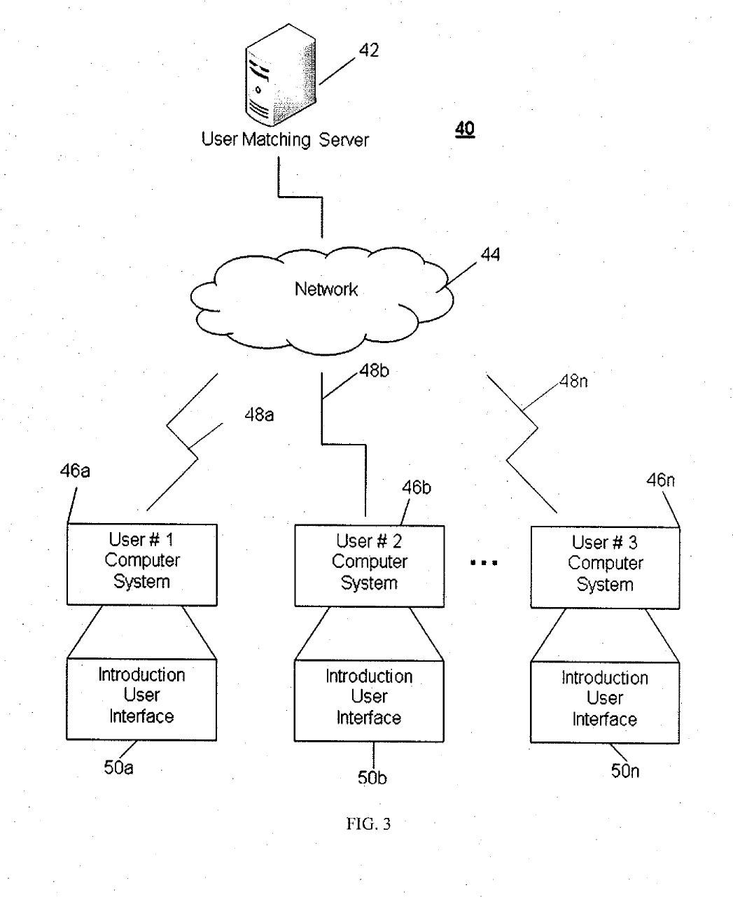

Social match recommendations are conveyed to the user via match recommendation user interfaces (UIs), as discussed in greater detail below in connection with FIG. 3. Based on uncertainty reduction theory, each party desires to gain adequate information about a person and their behavior to become comfortable enough to introduce personal information. Therefore, users are able to interact with potential matches using the introduction UIs of the systems and methods of the present disclosure, which ensure safe and anonymous introductions and helps them decide about accepting or denying a match. Initial interaction via indirect means is slower than real-time interaction, and carries the risk of participants losing interest, especially if the individuals interacting are complete strangers with no social links between them. The introduction mechanism is a direct, real-time interaction that enables matched users to communicate and exchange information before making a decision. An example of such an introduction mechanism is set forth in Raban, et al., “Hello, Stranger! A Study of Introductory Communication Structure and Social Match Success,” IEE Hawaii International Conference on System Sciences (HICSS-42), 2009, the entire disclosure of which is expressly incorporated herein by reference.

Another concern addressed by the systems and methods of the present disclosure relate to communication between matched users and their privacy and anonymity. Information exchanged by users, as well as the introduction phase, pose a risk of unwanted identifications. Any new piece of information revealed by one party can potentially reduce the uncertainty of her/his match about her/his identity and lead to an identity inference. An example of this risk is illustrated as follows:

Bob engages in an online communication with Alice. At the start of communication, Bob does not know anything about his experimental chat partner. After a while, Alice reveals that she is Hispanic and she plays for women's soccer team. Bob, who has seen the soccer team playing before, knows that there is only one Hispanic female member and infers Alice's identity at physical appearance granularity. At this point, while Alice thinks she kept her identity a secret, Bob knows who she is because there is only one possible value for her identity.

Since the risk such identity inferences is associated with information entropy, matching based on the rarity of the match poses a higher inference risk. This means that user anonymity protection systems can be utilized by the systems and methods of the present disclosure to protect against inference risks. Methods of predicting and managing the inference risk in order to protect users' identity are disclosed in co-pending U.S. patent application Ser. No. 12/507,508, the entire disclosure of which is expressly incorporated herein by reference.

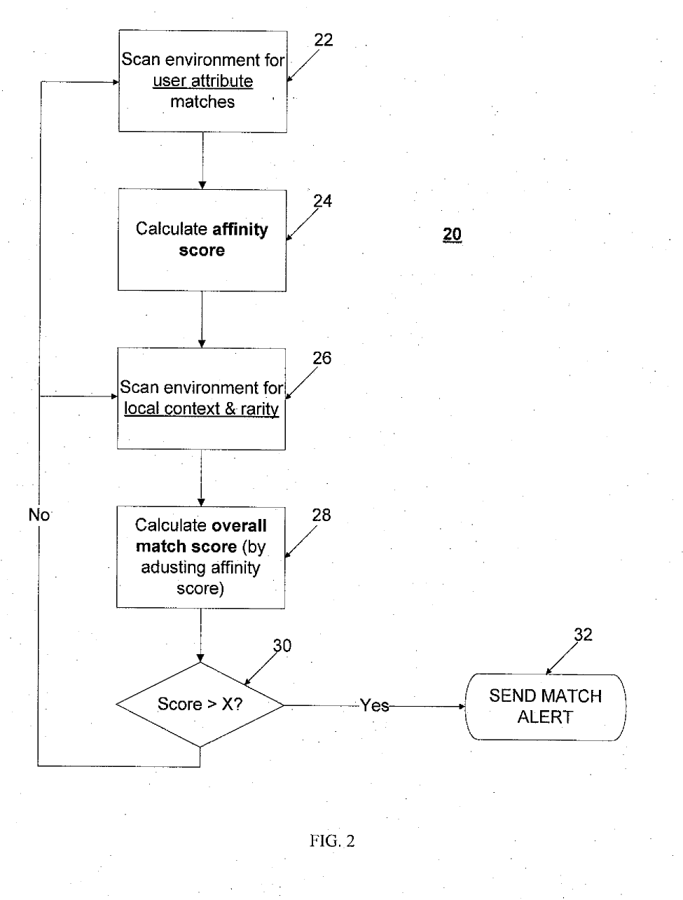

FIG. 2 is a flowchart showing processing steps, indicated generally at 20, carried out by the matching algorithm according to the systems and methods of the present disclosure, which uses the aforementioned reasons for matchmaking to recommend matches between users. Beginning in step 22, the algorithm scans a user environment (e.g., a database containing information about one or more users of the system, and/or real-time information provided to the system relating to information about one or more users) to identify user attribute matches. Then, in step 24, the algorithm calculates a numeric affinity score based upon the identified user attributes. In general, the higher the affinity score is, the more likely it will be that there is a match between the individuals suitable for recommendation.

In step 26, the algorithm scans the environment to identify users' local context as well as social relevance (match rarity). Then, in step 28, the algorithm adjusts the affinity score using the local context and social context (match rarity) information, and calculates an overall match score. For example, if, in step 24, match rarity is determined to be high, then the affinity score could be increased. In step 30, a determination is made as to whether the overall match score is greater than a pre-defined threshold X (which could be user-defined), X being a numeric value. If so, step 32 occurs, wherein a match alert is sent to the users who have been identified by the algorithm has constituting a match. Otherwise, steps 22 and 26 are invoked and the algorithm 20 repeated, so that further monitoring of users and determination of potential user matches can occur.

It is noted that the two measures of the match algorithm are the affinity score and the overall match score. The affinity score is based on the number of user attributes which two users have in common. Thus, for example, the users having a higher number of common user attributes receive a higher affinity score. The overall match score weights users' local context and the match rarity, and adjusts the affinity score accordingly.

The algorithm 20, discussed above in connection with FIG. 2, could also be expressed as follows:

1. Collect all attributes that user A's match can satisfy, including:
a. Making a rich profile including all information and characteristics collected from the user profile, activities, social ties, etc.;
b. Asking for the attributes that the user wants a match to satisfy; and
c. His/her social ties.

2. Collect user A's local context and location traces.

3. For each user B as a possible match in the system:
a. Find all the attributes of B that matches A's attributes or his specified preferences mentioned in a, b, and c;
b. Calculate B's affinity score, A_{B}, based on the foregoing information;
c. Calculate B's contextual score, C_{B}, which indicates suitability of the context (such as the location) of matching;
d. Compute B's match rarity score, U_{B}, which represents the number of users that match with A based on at least everything that B matches with A (at least have the same characteristics and/or match the same specified preferences);
e. Compute B's contextual rarity score, U_{B}, which is the number of users that match with A based on at least everything that B matches with A and are in the same context (e.g. share the same location or same proximity history); and
f. Compute B's overall match score, which is a weighted combination of affinity, contextual, rarity, and contextual rarity scores, (e.g., expressed by the formula F(w₁·C_{B}+w₂A_{B}+w₃·1/U_{B}+w₄·1/U_{B})). It is possible to adjust the emphasis on each measure by changing the ratio of the parameters w₁, . . . , w₄. If w₁, w₃, w₄ are set to zero, the model will be similar to previous matching approaches in which only affinity score is considered.

4. Select the matches whose overall match scores are above a preset level.

FIG. 3 is a diagram showing exemplary hardware and software components that could be utilized to implement the systems and methods of the present disclosure. The system is indicated generally at 40. The match recommendation functions provided by the systems and methods of the present disclosure could be embodied as computer-readable code executed by a suitable computer system, such as a user matching server 42. The server 42 could be in communication with a network 44, such as the Internet, an intranet, extranet, local area network (LAN), wide area network (WAN), campus area network (CAN), metropolitan area network (MAN), wireless network, optical network, cellular network, etc. A plurality of user computer systems 46a-46n (n being any integer) are in communication with the user matching server 42 via communications paths 48a-48n and the network 44. The user computer systems 46a-46n display user interfaces 50a-50n which allow users to specify search queries and to search for other matching users of the system 40. The user interfaces 50a-50n could be local software applications executing on the computer systems 46a-46n, and/or they could be web browser-based interfaces, etc. The user interfaces 50a-50n provide information about users of the computer systems 46a-46n to the user matching server 42, and they receive recommendations for matches generated by the matching server 42. Additionally, the user interfaces 50a-50n display alerts to the users regarding potential matches, and allow users to selectively communicate with matching users, if desired. The user computer systems 46a-46n could be any suitable computing devices having the ability to communicate with the network 44, such as personal computers, laptop computers, handheld computers, personal digital assistants (PDAs), cellular telephones, smart phones, etc.

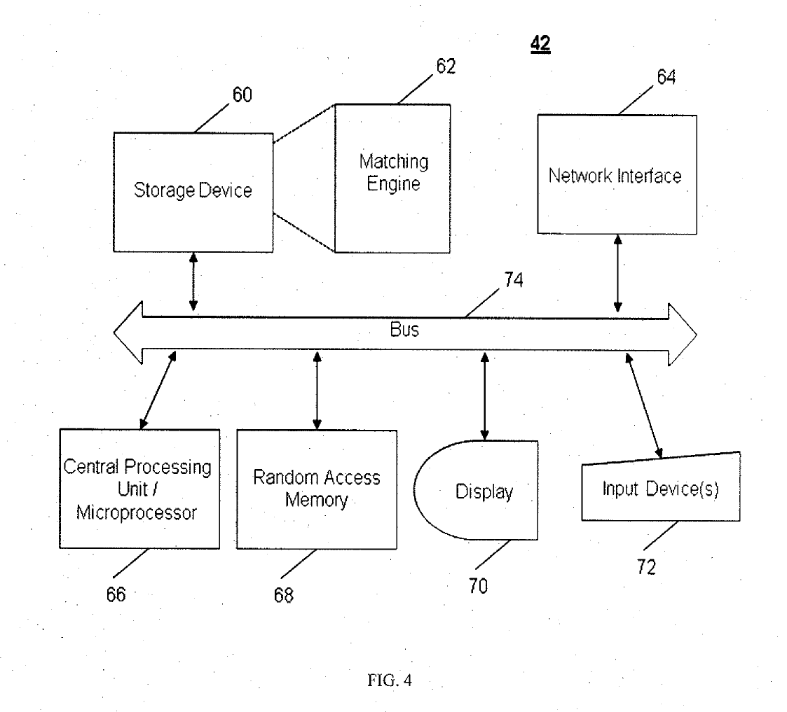

FIG. 4 is a diagram showing exemplary hardware and software components of the user matching server 42 of FIG. 3, in greater detail. The matching server 42 includes a storage device 60, a network interface device 64, a communications bus 74, a central processing unit (CPU) (microprocessor) 66, a random access memory (RAM) 68, a display 70, and one or more input devices 72, such as a keyboard, mouse, etc. The storage device 60 could comprise any suitable computer-readable storage medium such as disk, non-volatile memory (e.g., EPROM, EEPROM, flash memory), etc. The functionality provided by the present invention could be provided by a matching engine 62, which could embodied as computer-readable program code stored on the storage device 60 and executed by the CPU 66, and could be coded using any suitable, high- or low-level computing language, such as Java, C, C++, C#, .NET, etc. The network interface 64 could include an Ethernet network interface device, a wireless network interface device, cellular transceiver, or any other suitable device, which permits the server 42 to communicate via the network 44 of FIG. 3. The CPU 66 could include any suitable single- or multiple-core microprocessor. It is contemplated that user computer systems 46a-46n of FIG. 3 can be provided with hardware and/or software components similar to those of server 42, and/or additional components.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention.

What is claimed is:

1. A method for matching individuals, comprising the steps of:
receiving at a matching server attribute information about a plurality of individuals;
receiving at the matching server a search query for an individual matching at least one desired characteristic specified by a user of the matching server;
calculating using the matching server an affinity score based upon the attribute information and the search query;
receiving at the matching server local user context information and social relevance information corresponding to the plurality of individuals;
calculating an overall match score at the matching server by adjusting the affinity score based upon the local user context information and the social relevance information;
determining whether the overall match score exceeds a pre-determined threshold; and
if the overall match score exceeds the pre-determined threshold, electronically transmitting an alert to the user of the matching server identifying potential matches in the plurality of individuals.

2. The method of claim 1, further comprising displaying the alert to the user on a local computer system operated by the user.

3. The method of claim 2, further comprising displaying the alert to the user on a mobile device operated by the user.

4. The method of claim 2, further comprising allowing the user to communicate with at least one of the potential matches.

5. The method of claim 1, wherein the attribute information comprises information relating to at least one of a user's interests, user demographics, geo-temporal patterns, a user's personality, a user's needs, a user's preferences, or social ties between at least two users.

6. The method of claim 1, wherein the local user context information comprises information relating to at least one of proximity, location, time, temperature, weather, mood, current task, or current activity.

7. The method of claim 1, wherein the social relevance information comprises information relating to at least one of match rarity or match prevalence.

8. A system for matching individuals, comprising:
a matching server in communication with a plurality of computer systems operated by a plurality of users of the matching server, the matching server receiving attribute information about a plurality of individuals;
means for receiving a search query for an individual matching at least one desired characteristic specified by a user of the matching server;
means for calculating an affinity score based upon the attribute information and the search query;
means for receiving local user context information and social relevance information corresponding to the plurality of individuals;
means for calculating an overall match score by adjusting the affinity score based upon the local user context information and the social relevance information;
means for determining whether the overall match score exceeds a pre-determined threshold; and
means for transmitting an alert to the user of the matching server identifying potential matches in the plurality of individuals, if the overall match score exceeds the pre-determined threshold.

9. The system of claim 8, further comprising a user interface at each of the plurality of computer systems operated by the users of the matching server for displaying the alert.

10. The system of claim 9, wherein the user interface is displayed on a mobile device operated by at least one of the users.

11. The method of claim 9, wherein the user interface allows a user to communicate with at least one of the potential matches.

12. The system of claim 8, wherein the attribute information comprises information relating to at least one of a user's interests, user demographics, geo-temporal patterns, a user's personality, a user's needs, a user's preferences, or social ties between at least two users.

13. The system of claim 8, wherein the local user context information comprises information relating to at least one of proximity, location, time, temperature, weather, mood, current task, or current activity.

14. The system of claim 8, wherein the social relevance information comprises information relating to at least one of match rarity or match prevalence.

15. A computer-readable medium having computer-readable instructions stored thereon which, when executed by a computer system, causes the computer system to execute the steps of:
receiving attribute information about a plurality of individuals;
receiving a search query for an individual matching at least one desired characteristic specified by a user of the matching server;
calculating an affinity score based upon the attribute information and the search query;
receiving local user context information and social relevance information corresponding to the plurality of individuals;
calculating an overall match score by adjusting the affinity score based upon the local user context information and the social relevance information;
determining whether the overall match score exceeds a pre-determined threshold; and
if the overall match score exceeds the pre-determined threshold, electronically transmitting an alert to the user of the matching server identifying potential matches in the plurality of individuals.

16. The computer-readable medium of claim 15, further comprising computer-readable instructions which cause the computer system to execute the step of displaying the alert to the user on a local computer system operated by the user.

17. The computer-readable medium of claim 16, further comprising computer-readable instructions which cause the computer system to execute the step of allowing the user to communicate with at least one of the potential matches.

18. The computer-readable medium of claim 15, wherein the attribute information comprises information relating to at least one of a user's interests, user demographics, geo-temporal patterns, a user's personality, a user's needs, a user's preferences, or social ties between at least two users.

19. The computer-readable medium of claim 15, wherein the local user context information comprises information relating to at least one of proximity, location, time, temperature, weather, mood, current task, or current activity.

20. The computer-readable medium of claim 15, wherein the social relevance information comprises information relating to at least one of match rarity of match prevalence.
